(19) United States
(12) Patent Application Publication
(10) Pub. No.: US 2025/0374168 A1
(43) Pub. Date: Dec. 4, 2025

(54) GRAPH-BASED COMMUNITY PAIRING FOR RADIO CLUSTERING

(71) Applicant: Dell Products L.P., Round Rock, TX (US)

(72) Inventors: Vamsi Krishna Boyapati, Metairie, LA (US); Satish Venkob, Mississauga (CA)

(21) Appl. No.: 18/677,168

(22) Filed: May 29, 2024

(51) Int. Cl. H04W 40/32; H04W 40/04

(52) U.S. Cl. CPC H04W 40/32; H04W 40/04

(57) ABSTRACT

A method facilitating graph-based community pairing for radio clustering includes constructing, by a system including at least one processor, a graph structure representative of a communication network, the graph structure including nodes representative of radio cells of the communication network and edges that associate the radio cells of the communication network with predicted network traffic patterns associated with the radio cells; clustering, by the system based on the graph structure, the radio cells according to a similarity criterion, resulting in clusters of the radio cells; and assigning, by the system, respective resources of the communication network to a cluster of the clusters of the radio cells.

### BACKGROUND

With the advent of virtualization technologies, Virtualized RAN (V-RAN) has emerged as a revolutionary concept within the RAN architectures such as the Fifth Generation (5G) RAN architecture. In general, V-RAN can leverage cloud-native virtualization techniques to transform traditional network functions into virtualized microservices or containers. This shift from purpose-built hardware to software-based solutions allows for greater flexibility, scalability, and cost-effectiveness in network deployments. V-RAN enables the disaggregation of network components, separating conventional network functions into software-based entities that can be dynamically deployed where needed, rather than relying on fixed, hardware-based deployments. However, given the proliferation of wireless devices and the growing demand for data-intensive applications, it is becoming increasingly desirable to implement techniques to enhance the energy efficiency of RAN deployments.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include generating a graph structure representative of a communication network, the graph structure including nodes respectively corresponding to radio cells in the communication network and edges that associate the radio cells with respective predicted patterns in traffic characteristics of the radio cells. The operations can further include grouping, based on the graph structure, the radio cells of the communication network into clusters of the radio cells according to a similarity criterion. The operations can also include assigning respective groups of resources of the communication network to a selected cluster of the clusters of the radio cells.

In another implementation, a method is described herein. The method can include constructing, by a system including at least one processor, a graph structure representative of a communication network, the graph structure including nodes representative of radio cells of the communication network and edges that associate the radio cells of the communication network with predicted network traffic patterns associated with the radio cells. The method can additionally include clustering, by the system based on the graph structure, the radio cells according to a similarity criterion, resulting in clusters of the radio cells. The method can further include assigning, by the system, respective resources of the communication network to a cluster of the clusters of the radio cells.

In an additional implementation, a non-transitory machine-readable medium is described herein that can include instructions that, when executed by at least one processor, facilitate performance of operations. The operations can include constructing a graph structure representative of a communication network, the graph structure including nodes representative of radio cells of the communication network and edges that associate the radio cells of the communication network with network traffic patterns predicted to be associated with the radio cells during a time interval; clustering, based on the graph structure, the radio cells according to a similarity criterion, resulting in clusters of the radio cells; and assigning a determined amount of resources of the communication network to a cluster of the clusters of the radio cells.

### DESCRIPTION OF DRAWINGS

Various non-limiting embodiments of the subject disclosure are described with reference to the following figures, wherein like reference numerals refer to like parts throughout unless otherwise specified.

FIGS. 1-4 are block diagrams of respective systems that facilitate graph-based community pairing for radio clustering in accordance with various implementations described herein.

FIG. 5 is a diagram of an example graph structure that can be generated in accordance with various implementations described herein.

FIG. 6 is a block diagram of another system that facilitates graph-based community pairing for radio clustering in accordance with various implementations described herein.

FIG. 7 is a diagram of an example architecture facilitating radio resource clustering, e.g., based on graph-based community pairing for radio clustering, in accordance with various implementations described herein.

FIGS. 8-9 are flow diagrams of respective methods that facilitate radio resource clustering, e.g., based on graph-based community pairing for radio clustering, in accordance with various implementations described herein.

FIGS. 10-11 are flow diagrams of respective methods that facilitate graph-based community pairing for radio clustering in accordance with various implementations described herein.

FIGS. 12 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

Advancements in wireless communication technology, such as the Fifth Generation (5G) Radio Access Network (RAN) architecture, are ushering in a new era of high-speed, low-latency connectivity. Such advancements can facilitate a diverse range of services and applications, from Internet of Things (IoT) devices to augmented reality experiences. With regard to the 5G RAN architecture in particular, said architecture comprises several key components, including Centralized Units (CUs), Distributed Units (DUs), and Radio Units (RUs), each of which play a role in delivering seamless connectivity.

Traditionally, the 5G RAN architecture involves a hierarchical structure where CUs, DUs, and RUs work together to facilitate wireless communication. CUs can be responsible for processing and managing higher-layer functions, such as user mobility and connection setup, while DUs can handle lower-layer functions such as baseband processing and radio resource management. RUs, on the other hand, can manage the transmission and reception of radio signals to and from user devices. As noted above, a Virtualized RAN (V-RAN) can also be used, which leverages cloud-native virtualization techniques to transform traditional network functions into virtualized microservices or containers.

Energy efficiency is of particular concern in modern RAN architectures, given the proliferation of wireless devices and the growing demand for data-intensive applications. For example, In the context of the 5G RAN architecture, challenges include the inability to dynamically adjust server resources to changing traffic patterns, accommodating diversity in user equipment, seamlessly integrating Machine Learning (ML) algorithms into CU and DU software, and obtaining timely predictive analytics. Existing architectures lack the flexibility to adapt to dynamic traffic fluctuations, optimize resource allocation for various devices, provide a streamlined framework for ML integration, and offer real-time predictive insights. These challenges hinder the network's ability to deliver efficient and adaptive operations in the era of 5G connectivity.

To the furtherance of the above and/or related ends, implementations described herein can optimize energy consumption by strategically managing CU and DU resources. For instance, implementations described herein can use Artificial Intelligence (AI) and/or ML algorithms to incorporate predictive analytics and geospatial-temporal data, which in turn can enable a communication system to make informed decisions regarding resource pooling and/or allocation based on anticipated network traffic demand.

Continuing the above, a RAN, such as a 5G RAN, presents a number of challenges to energy efficiency. These can include, but are not limited to, the following:

Continuous Operation: Traditional base stations can operate continuously, e.g., 24 hours a day, 7 days a week, consuming energy even during low traffic periods.

Mismatch with Traffic Patterns: Traffic patterns such as Ultra-Reliable Low Latency Communication (URLLC), Massive Machine-Type Communications (mMTC), and Enhanced Mobile Broadband (eMBB) traffic patterns differ, leading to energy waste.

Lack of Adaptability: A traditional RAN lacks adaptability to dynamically adjust resources based on traffic.

Resource Overprovisioning: Resources are often overprovisioned to ensure reliability; however, this overprovisioning leads to energy inefficiency.

In addition, a 5G RAN and/or other RAN can present challenges to dynamic computational resource allocation that can include, but are not limited to, the following:

Diverse Traffic Types: Communication networks can serve varied traffic types with distinct latency and data rate requirements.

Combinatorial Complexity: Optimally allocating resources for diverse traffic types in dynamic networks is complex.

Energy Efficiency: Traditional RANs waste energy by operating continuously, regardless of traffic load.

To address the above and/or other challenges, implementations described herein provide a solution centered around RAN energy efficiency through the utilization of a traffic-aware data and AI system. Implementations described herein can optimize network operations, adapt to dynamic traffic demands, accommodate diverse user equipment, seamlessly integrate ML algorithms into CU and DU software, and deliver real-time predictive analytics to ensure efficient and adaptive 5G RAN connectivity.

It is noted that while various examples provided herein relate to 5G deployments, these examples are provided merely for illustrative purposes and are not intended to limit the description or the claimed subject matter to any particular network standard(s) or technology (-ies) unless explicitly stated otherwise. It is also noted that, due to the nature and quantity of data that can be processed by machine learning (ML) models as described herein, as well as the manner in which such data is processed, implementations described herein can facilitate operations that could not be performed in the human mind, or by a general-purpose computer utilizing conventional computing techniques, in a useful or reasonable timeframe.

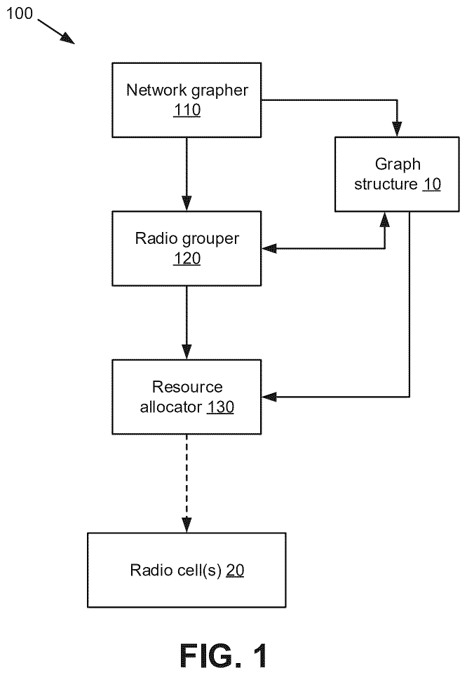

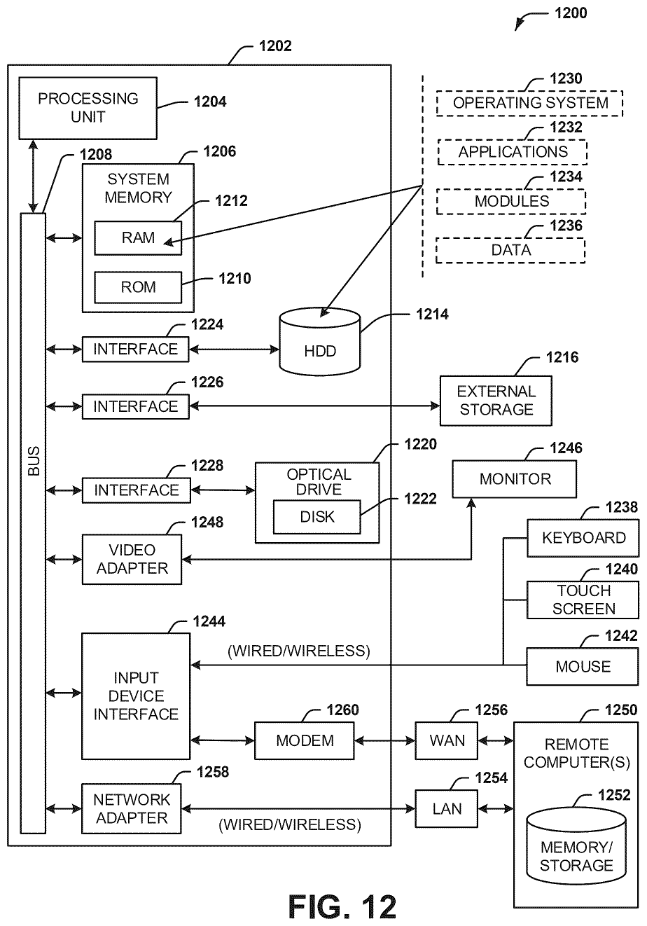

With reference now to the drawings, FIG. 1 illustrates a block diagram of a system 100 that facilitates graph-based community pairing for radio clustering in accordance with various implementations described herein. System 100 as shown in FIG. 1 includes executable components, e.g., a network grapher 110, a radio grouper 120, and a resource allocator 130, each of which can operate as described in further detail below. In an implementation, the components 110, 120, 130 of system 100 can be implemented in hardware, software, or a combination of hardware and software. By way of example, the components 110, 120, 130 can be stored on at least one memory and executed by at least one processor. An example of a computer architecture including a processor and memory that can be used to implement the components 110, 120, 130, as well as other components as will be described herein, is shown and described in further detail below with respect to FIGS. 12.

Additionally, it is noted that the functionality of the respective components shown and described herein can be implemented via a single computing device and/or a combination of devices. For instance, in various implementations, the network grapher 110 shown in FIG. 1 could be implemented via a first device, the radio grouper 120 could be implemented via the first device or a second device, and the resource allocator 130 could be implemented via the first device, the second device, or a third device. Also, or alternatively, the functionality of a single component could be divided among multiple devices in some implementations.

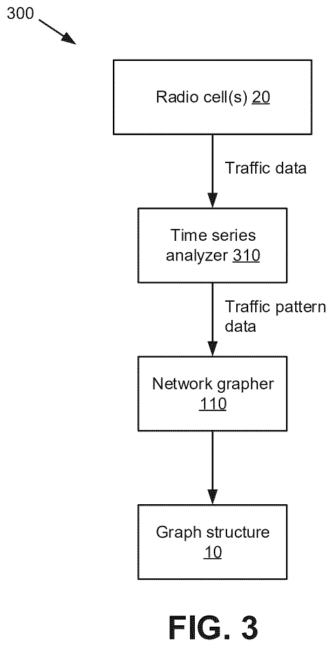

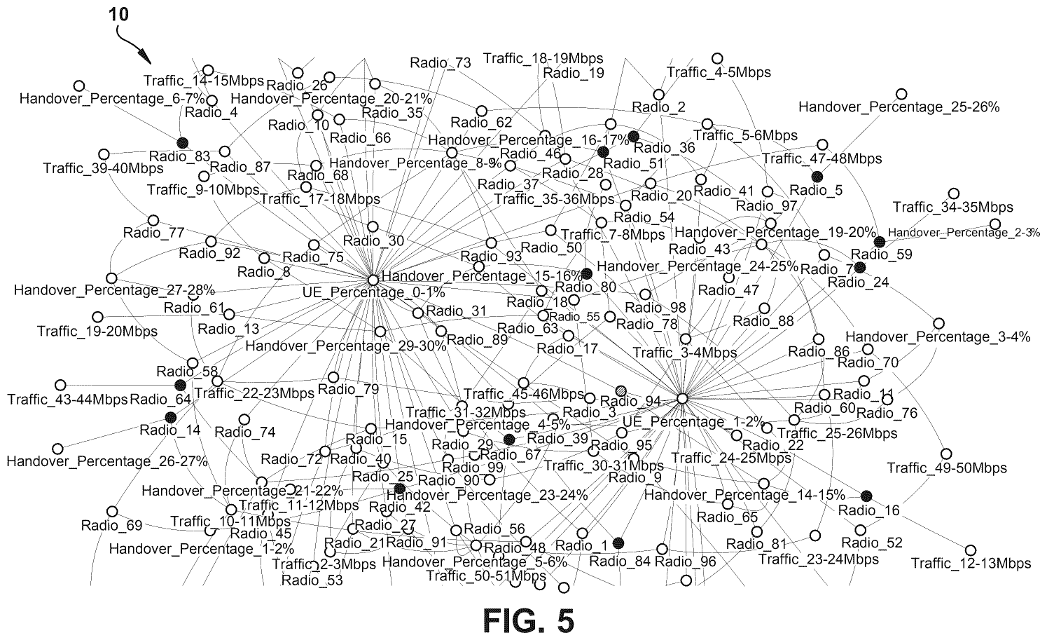

With reference now to the components of system 100, the network grapher 110 can generate a graph structure 10 representative of a communication network, such as a 5G RAN and/or another suitable communication network. The graph structure 10 can include nodes respectively corresponding to radio cells 20 in the communication network, which can be associated with CUs, DUs, and/or other entities in the communication network. The graph structure 10 can further include edges that associate the radio cells 20 of the communication network with respective predicted patterns in traffic characteristics of the radio cells 20. In an implementation, these patterns can be determined via time series analysis, e.g., as will be described in further detail below with respect to FIG. 3. Additionally, an example of a graph structure 10 that can be generated by the network grapher 110 is described in further detail below with respect to FIG. 5.

The radio grouper 120 of system 100 can cluster or otherwise group, based on the graph structure 10, the radio cells 20 of the communication network into clusters of the radio cells 20 according to a similarity criterion. In one example, a similarity criterion utilized by the radio grouper 120 can be based on Jaccard indices representative of the similarity of respective pairs of the radio cells 20, as will be described in further detail below.

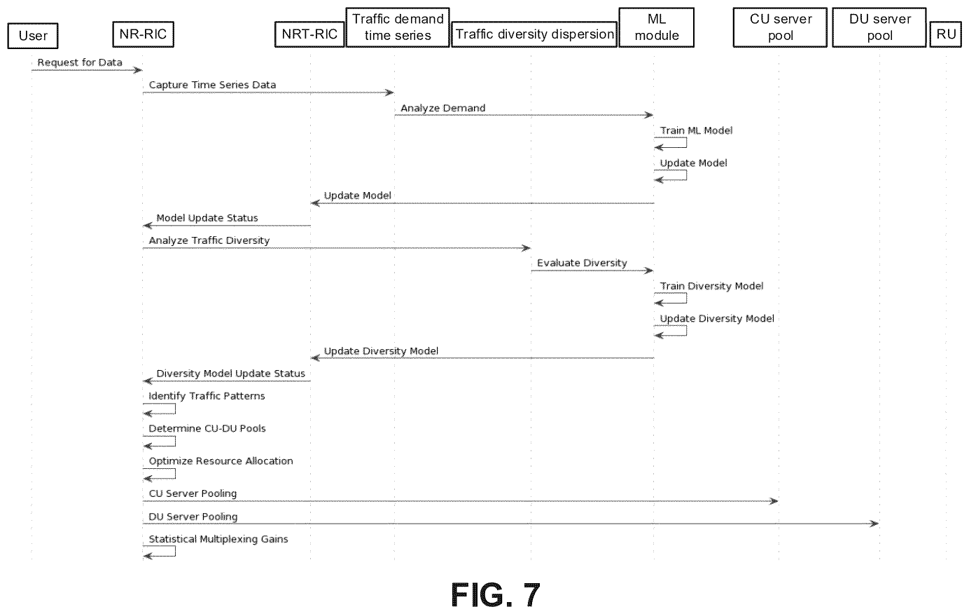

The resource allocator 130 of system 100 can assign respective groups of resources of the communication network, such as computing resources associated with servers or portions of servers (e.g., processing cores, etc.) to a selected cluster of the clusters of the radio cells 20 determined by the radio grouper 120. Various processes that can be used by the resource allocator 130 for assigning network resources to clustered radio nodes are described below with respect to FIGS. 7-9.

System 100 as shown in FIG. 1 can facilitate grouping of baseband units (BBUs) and/or other radio cells 20, from which a number of BBU servers, or other resources associated with handling an anticipated future load of the radio cells 20, can be predicted based on the grouping. For instance, in a cell site covering a substantial geographic area (e.g., an area spanning several hundred square kilometers), multiple radios can serve a diverse array of UEs. The distribution of UEs across different service categories, including URLLC, mMTC, and eMBB, can vary relatively quickly over time, e.g., hourly. To optimize resource allocation and network performance, system 100 can identify and group areas with similar traffic demands. As described herein, communities with similar traffic needs can be identified via graph community pairing.

Significant challenges can arise when provisioning baseband computing resources for radios in both macro and micro scenarios, where resources are often allocated without consideration of traffic patterns. Traffic volume, being directly proportional to utilized compute resources, can play a central role in this context. The absence of traffic awareness can lead to substantial inefficiencies, including wasted computing and energy resources.

Moreover, in urban macro deployments, the spatial and temporal distribution of traffic, characterized by data volumes and the number of devices connected at specific locations and times, can exhibit high levels of sparsity. To this end, system 100 can provide a RAN with the capability to recognize low-latency interval traffic patterns in a spatio-temporal matrix dynamically. Incorporating dynamic sensing into RAN infrastructure can significantly enhance its efficiency by adjusting resource allocation based on real-time traffic data, thereby reducing unnecessary resource consumption and improving overall network performance.

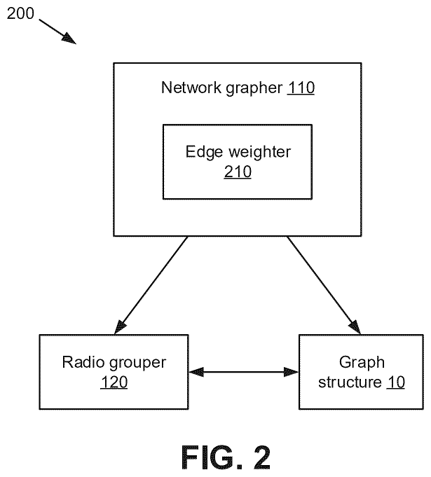

Turning next to FIG. 2, a block diagram of another system 200 that facilitates graph-based community pairing for radio clustering is illustrated. Repetitive description of like parts described above with regard to other implementations is omitted for brevity. System 200 as shown in FIG. 2 includes a network grapher 110, which can generate a graph structure 10 for a group of radio cells 20 in a communication network as described above with respect to FIG. 1. As further shown in FIG. 2, the network grapher 110 of system 200 includes an edge weighter 210 that can apply weights to the edges of the graph structure 10 based on at least one weighting factor, such as one or more weighting factors as provided below. The radio grouper 120 of system 200 can then group the radio cells based on the graph structure 10, e.g., using a similarity criterion that relates to the weights applied to the edges of the graph structure 10 by the edge weighter 210.

In an implementation, the network grapher 110 and edge weighter 210 shown in system 200 can construct a graph structure 10 that enables the definition of edges and nodes based on a comprehensive set of criteria, which can in turn enhance the accuracy of traffic demand community pairing. Criteria that can be used by the edge weighter 210 for edge weight determination can include, but are not limited to, the following.

Distance Between Cells (Spatial Proximity): The distance between adjacent radio cells can be considered, ensuring that cells in close geographic proximity are strongly connected in the graph structure 10. This can account for spatial correlation in traffic patterns.

Time Between Burstiness of Traffic: The timing of traffic bursts in adjacent cells can be evaluated by the edge weighter 210. If, for example, two cells experience bursty traffic patterns around the same time, they can relate to a higher edge weight. This can capture temporal synchronization in traffic demand.

Dispersion in UE Distribution: The edge weighter 210 can quantify the dispersion and/or spread of UE distribution within cells. Cells with similar dispersion patterns can be linked with higher weights, indicating similarity in UE distribution characteristics.

UE Mobility: UE mobility patterns can be considered by the edge weighter 210 when determining edge weights. Cells with UEs exhibiting similar mobility behavior, such as frequent handovers or stationary usage, can relate to higher weights. In an implementation, the edge weighter 210 can assign a handover index to respective radio cells, which can define, e.g., how quickly handovers are occurring for the UEs in a given cell within a given time.

In an implementation, nodes in the graph structure 10 can represent radio cells, each associated with its CU and DU. The nodes-and-edges structure of the graph can enable the radio grouper 120 to perform effective community pairing.

With reference now to FIG. 3, a block diagram of still another system 300 that facilitates graph-based community pairing for radio clustering is illustrated. Repetitive description of like parts described above with regard to other implementations is omitted for brevity.

With reference now to FIG. 3, a block diagram of still another system 300 that facilitates graph-based community pairing for radio clustering is illustrated. Repetitive description of like parts described above with regard to other implementations is omitted for brevity. System 300 as shown in FIG. 3 includes a time series analyzer 310, which can provide predicted traffic pattern data to the network grapher 110, e.g., for use in creating a graph structure 10 corresponding to respective radio cells 20 as described above with respect to FIG. 1. In addition, the time series analyzer 310 can identify changes to the predicted traffic patterns of respective radio cells 20, based on which the network grapher 110 can adjust the graph structure 10 as appropriate. By continuously monitoring and adapting identified communities of radio cells and associated resource allocation strategies as traffic patterns evolve, system 300 can facilitate ongoing optimal network performance.

In an implementation, the time series analyzer 310 can facilitate time series prediction of radio unit traffic, traffic diversity, mobility attributes, and/or other properties of radio cells 20 using data collected and pipelined into the time series analyzer 310 from each radio cell 20. A data architecture that can be utilized by the time series analyzer 310 for this purpose is described in further detail below with respect to FIG. 7. The output of the time series analyzer 310 can include, for example, predicted radio traffic, traffic diversity, mobility, and/or other metrics for respective radio cells 20 for defined time periods (e.g., one-hour intervals, 15-minute intervals, etc.).

Based on the predicted traffic data for the radio cells 20 for a given future time period as determined by the time series analyzer 310, the network grapher 110 can construct a graph structure 10 that reflects the predicted state of the radio cells 20 at that future time, enabling an optimal amount of computing resources to be allocated to the radio cells 20 based on their predicted needs over the time period. The time series analyzer 310 can then continue predicting the traffic characteristics of the radio cells 20 for future time periods, thereby enabling the network grapher 110 to update the graph structure 10 to reflect changing needs of the network. As a result, system 300 can facilitate the allocation of a reduced amount of computing resources to the radio cells 20 based on their actual predicted needs for a given time interval, e.g., as opposed to a system that does not perform time series analysis that must allocate resources associated with worst-case usage patterns at all times to prevent degradation of service and ensure service level agreements (SLAs) associated with the radio cells 20 are maintained.

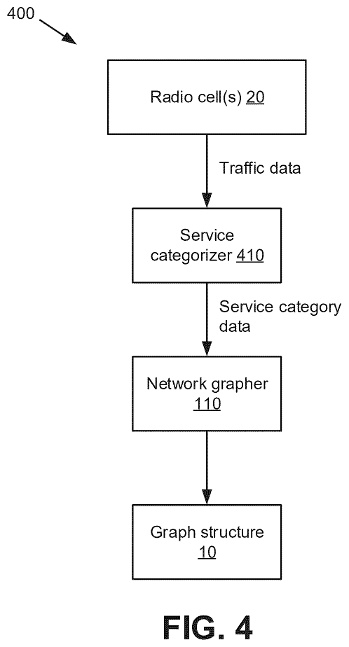

Moving now to FIG. 4, a block diagram of a further system 400 that facilitates graph-based community pairing for radio clustering is illustrated. Repetitive description of like parts described above with regard to other implementations is omitted for brevity. System 400 as shown in FIG. 4 includes a service categorizer 410, which can analyze data relating to network traffic served by respective radio cells 20 to identify service categories associated with the respective radio cells 20. Examples of service categories that can be identified by the service categorizer 410 can include, e.g., URLLC, mMTC, eMBB, and/or other suitable service categories. Data relating to the service categories identified by the service categorizer 410 can then be provided to the network grapher 110, e.g., as an input for construction of a graph structure 10 corresponding to the radio cells 20 as described above with respect to FIG. 1.

With reference next to FIG. 5, a partial view of an example graph structure 10 that can be generated by a network grapher 110, such as the network grapher 110 of system 100, in accordance with various implementations as described herein is illustrated. In an implementation, the graph structure 10 shown in FIG. 5 can be a weighted graph, where each node corresponds to a radio cell 20, e.g., a radio cell 20 equipped with a CU and DU. The network grapher 110 can (e.g., via the edge weighter 210 as described above with respect to FIG. 2) assign weights to the edges between the nodes based on various criteria such as those described above, thereby capturing both spatial and temporal correlations. By way of example, for respective pairs of adjacent cells in the graph structure 10, the network grapher 110 can calculate edge weights by considering the distance between cells, synchronization of traffic bursts, dispersion in UE distribution, UE mobility, and/or other factors.

Based on a graph structure 10 such as that shown by FIG. 5, a radio grouper 120, such as the radio grouper 120 shown in FIG. 1, can utilize community detection algorithms, such as Louvain Modularity, spectral clustering, or the like, to partition the graph structure 10 into communities. These communities can represent groups of radio cells 20 with similar traffic demand patterns. Subsequently, as described above with respect to FIG. 4, an in-depth analysis of each identified community can be conducted, e.g., by the service categorizer 410 of system 400, to examine the dominant service categories (e.g., URLLC, mMTC, eMBB, etc.) within each community, temporal traffic trends, UE mobility behaviors, and/or other properties of the radio cells 20.

In the example graph structure 10 shown by FIG. 5, respective communities of radio cells 20 are denoted via shading, e.g., such that each set of similarly-shaded nodes in the graph structure 10 represents a community of radio nodes that share commonalities in terms of one or more properties, such as UE handover rate, traffic data rate, and/or other properties. In the specific non-limiting example shown by FIG. 5, the communities can differ significantly in terms of size at a given point in time. This could be due to one type of radio cell (such as IoT cells or the like) being dominant in a given area, the graph structure 10 representing a time of day in which many of the radio cells 20 are inactive, and/or other reasons. In the latter case, it is noted that the communities could be significantly different at a different time of day in which the radio cells 20 are more active.

In an implementation, the radio grouper 120 can determine communities of radio cells 20 based on a graph structure 10 of the radio cells 20 at a given time using Jaccard's pairing logic, which is well suited for sparse distributions. In the example shown in FIG. 5, the lengths of the graph edges are used to represent the weights, e.g., such that a longer edge is associated with a lower weight, and vice versa. It is noted that as the weights of the respective edges are expected to at least partially change over time, the positions of the nodes of the graph will similarly shift to reflect updates to the edge weights.

By utilizing Jaccard's pairing logic, e.g., based on Jaccard indices as noted above, different weighting factors can also be given different weights as appropriate. For instance, if data throughput is determined to be the most important factor for radio grouping, a higher weight can be given to throughput while lower weights can be given to other characteristics, such as mobility or the like. In this way, the radio grouper 120 can configure the significance of each variable represented in the graph structure 10.

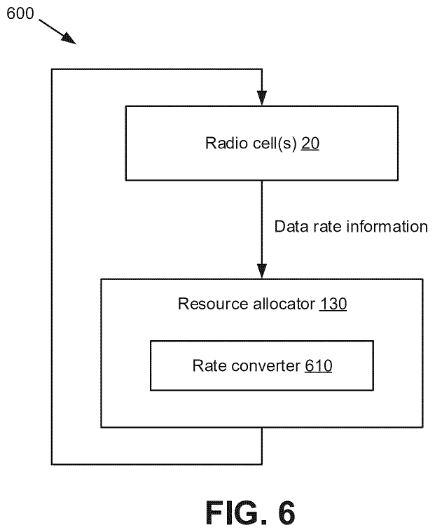

Turning to FIG. 6, a block diagram of another system 600 that facilitates graph-based community pairing for radio clustering is illustrated. Repetitive description of like parts described above with regard to other implementations is omitted for brevity. System 600 as shown in FIG. 6 includes a resource allocator 130, which can determine a resource allocation for respective communities of radio cells 20 as partitioned in accordance with various implementations described above.

To this end, the resource allocator 130 includes a rate converter 610, which can estimate an average data rate (e.g., in gigabytes per second or GBPS) processed by a selected cluster of radio cells 20 over a given time interval, e.g., based on predicted patterns in the traffic characteristics of the radio cells 20 as described above. Based on this estimate, the rate converter 610 can determine an amount of computing resources associated with processing network traffic at the selected cluster of the radio cells 20 at the average data rate, e.g., in terms of giga-operations per second (GOPS) and/or other suitable metrics. The resource allocator 130 can then assign the amount of computing resources determined by the rate converter 610 to the selected cluster of radio cells 20.

In an implementation, the rate converter 610 can determine the GOPS associated with a given data rate based on the data rate itself as well as additional factors, such as those associated with the modulation, coding, and/or transmission of the data at the given data rate. By way of a specific, non-limiting example in which data is transmitted from a given radio cell 20 with a Fast Fourier Transform (FFT) size of 2048 and a subcarrier spacing that results in a symbol rate of 15 kHz, various factors that can be used by the rate converter 610 to compute the associated GOPS can include, but are not limited to, the following:

Operations per FFT: In the above example, the operations per FFT would include log₂ (2048) complex multiplications, plus approximately the same number of complex additions.

Symbol rate: This parameter can depend on the specific frame structure and subcarrier spacing used. In the example of a 15 kHz subcarrier spacing, this can be the inverse of the Orthogonal Frequency Division Multiplexing (OFDM) symbol duration, which includes the cyclic prefix.

Throughput per symbol: This parameter can depend on the modulation scheme (e.g., 64-QAM, 256-QAM, etc.) and the code rate.

Based on the above, a simplified approximation of the GOPS for a radio cell 20 with an FFT size of 2048 and a symbol rate of 15 kHz (e.g., a typical rate for one OFDM symbol including a cyclic prefix in 5G), the computational load for the associated FFT operations is approximately 2.7 GOPS. In implementations, bootstrapping methods can be used to establish relationships between the network traffic, mobility, and/or other parameters of variance that can affect the data rate to GOPS conversion.

With reference next to FIG. 7, an architectural representation of an algorithm that can be run by an Open RAN (O-RAN) RAN Intelligent Controller (RIC) for providing the instructions for pooling server resources in the CU and DU, e.g., based on radio clustering as described above, is illustrated. The user shown in FIG. 7 can represent a network operator or other administrator, and the arrows indicate data flows between the RAN and RIC components. As shown in FIG. 7, the NR-RIC is a non-real-time RIC, and the NRT-RIC is a near-real-time RIC, e.g., a RIC that can perform actions at regular intervals (e.g., 15-minute intervals, and/or other suitable intervals). It is also noted that the process shown in FIG. 7 can be performed for a cloud-based RAN, e.g., a RAN that utilizes virtualized network components running on poolable servers.

The process shown in FIG. 7 is initiated by a request for data provided by the user to the NR-RIC, which initiates capturing time series data. This time series data is analyzed by the traffic demand time series block, which is an algorithmic layer that estimates traffic demand using the time series data. This estimated demand is then provided to a machine learning (ML) module, which trains and updates an ML model based on the estimated demand. The model updates are then provided to the NRT-RIC, which updates the NR-RIC accordingly.

Next, the NR-RIC initiates analysis of associated traffic diversity by a traffic diversity dispersion algorithmic block. The evaluated diversity can then be provided to the ML module, which can train and update a diversity model that can be provided to the NRT-RIC and the NR-RIC as shown in FIG. 7.

Based on the models provided to the NR-RIC, the NR-RIC can then identify patterns in the traffic data, determine appropriate pools of CUs and/or DUs, and optimize the resource allocation to the CUs and DUs. The NR-RIC can then facilitate server pooling for the CUs and DUs, e.g., by facilitating pooling of CU/DU resources in the cloud for identified communities of the CUs and/or DUs. While FIG. 7 shows an example in which both CU and DU servers are pooled, it is noted that pooling could also be performed for only CUs, or only DUs, depending on implementation.

As shown in FIG. 7, the illustrated server pooling process can result in statistical multiplexing gains, e.g., associated with a reduction in computing resources associated with allocating resources to communities of radios instead of uniform groups of radios that are not clustered according to communities. Additionally, the analysis steps shown in FIG. 7 can be repeated at regular intervals, e.g., intervals at which the NRT-RIC operates, to ensure that statistical multiplexing gains continue to be realized over time.

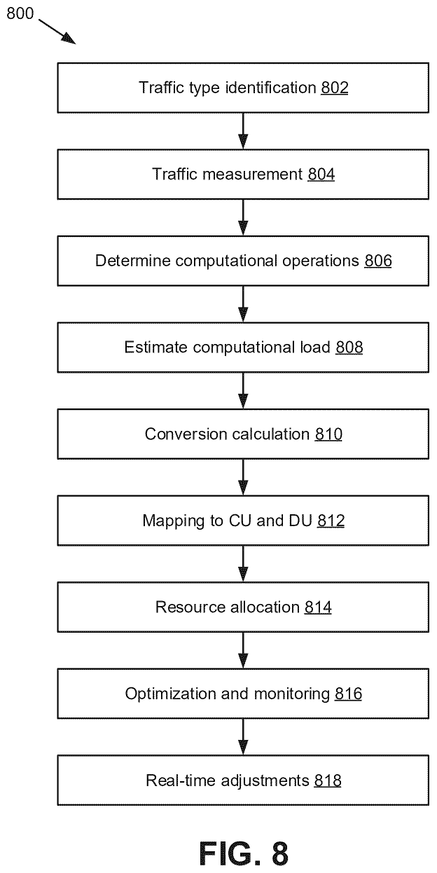

Turning next to FIG. 8, a flow diagram of an example process 800 that can be performed by server pooling logic, e.g., logic associated with the NR-RIC and/or NRT-RIC shown in FIG. 7, is illustrated. The process 800 shown by FIG. 8 can begin with traffic type identification 802 and traffic measurement 804 for a given traffic flow, which can include remote sensing based on data captured on the network. Next, at 806, the computational operations associated with the identified and measured traffic can be determined, based on which a computational load can be estimated at 808.

At 810, the computational load estimated at 808 can be converted into an amount of data operations, and the converted amount of data operations can be mapped to a number of CUs and/or DUs at 812. Resource allocation can then be performed at 814 based on the number of CUs and/or DUs, and this resource allocation can be optimized and/or monitored at 816. Additionally, real-time adjustments can be made to the resource allocation at 818.

In an implementation, the amount of compute resources, e.g., as expressed as a number of computation servers, to be allocated for respective remote radio heads (RRHs) can be implemented via a function that takes two input parameters. First, a user_loads parameter can be used, which can be a list of lists where each inner list represents the loads of a given RRH. Each list can include a task load value and a communication load value, and collectively this parameter can represent the resource demands of each RRH. Second, a maximum_capacity parameter can be used that can represent the maximum capacity of each computation server, e.g., as expressed as the maximum GOPS a server can perform and/or in another suitable manner. This parameter can signify the maximum amount of workload that a single server can handle.

Based on the above input parameters, the above-noted resource estimation function can perform the following steps:

Calculating RRH and task counts: The function can begin by determining the number of RRHs and tasks based on the length of the user_loads list. This can provide the dimensions for subsequent calculations.

Calculating resource requirements per task: The function can then calculate the resource requirements for each task of each RRH. To do this, it can normalize the task loads based on the total load of each RRH. These normalized values can be stored in a task_values list, which represents the resource requirements for each task.

Calculating total resource requirements per RRH: Next, the function can calculate the total resource requirements for each RRH by summing the task_values list along its first axis. This step can result in a list of total resource requirements for each RRH.

Task allocation matrix initialization: The function can then initialize a task allocation matrix xi with all ones. This matrix can be used to allocate tasks to servers.

Calculating total resource use: The function can then calculate the total resource used by each server for each RRH. It can do this by multiplying matrix xi with the resource requirements and summing along the first axis. This step can result in a matrix rho_server, which represents the total resources used by each server for each RRH.

Determining number of computation servers: Finally, the function can determine the total number of computation servers to allocate. It can achieve this by finding the maximum value in the rho_server matrix, e.g., the highest resource usage among all servers, and then dividing this maximum value by the maximum_capacity parameter. The result can be rounded up to ensure that enough servers are provisioned to handle the loads effectively.

As a result of the above steps, the function can return the computed number of computation servers that are determined to meet the specified user loads and maximum capacity.

By utilizing server allocation procedures such as those described above with respect to FIGS. 7-8, various advantages can be achieved. These advantages can include, but are not limited to, the following:

Resource optimization: By using the data-driven approach shown in FIGS. 7-8, servers can be allocated as per actual requirements, which can save significant resources as compared to a system in which no analysis is performed and a worst case number of servers are allocated at all times.

Peak hour preparedness: The approach shown in FIGS. 7-8 can enable the provisioning of full servers during peak hours, ensuring that quality of service is maintained without overprovisioning.

Cluster-based contingency: Having different clusters with known estimated traffic can enable diversion of traffic in the event of a failure. This can ensure that quality of service is not significantly reduced and provide a robust mechanism to maintain user experience.

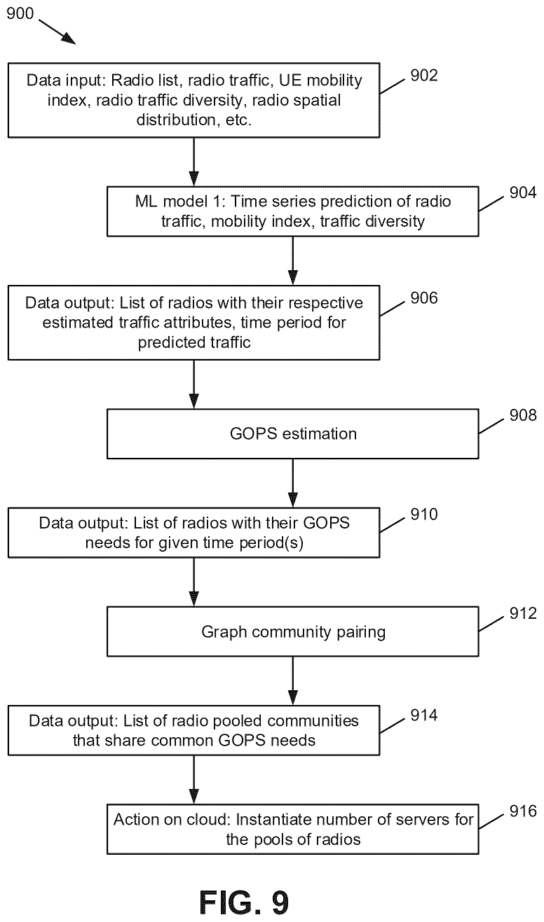

With reference now to FIG. 9, a flow diagram of an additional process 900 for data-driven server allocation for radio cells 20 is illustrated. FIG. 9 is shown in a staggered format, in which the blocks on the left-hand side represent data inputs and outputs while the blocks on the right-hand side represent data operations. In general, the process 900 shown in FIG. 9 can be used to address the challenges of energy efficiency in baseband processing, e.g., for 5G technologies, via the use of actions that can include, but are not limited to, the following:

1) Computing an amount of server resources to allocate based on the number of cores, which can be estimated by calculating the GOPS as derived from the GBPS at the radio level. The parameters affecting the GBPS can include traffic and mobility attributes at the radio.

2) Identifying the optimal set of radio pools and organizing them into distinct clusters, e.g., through the use of graph community pairing. This can be achieved by employing label propagation and Louvain modularity models, e.g., based on the estimated GOPS requirements from step 1 above.

3) For near real-time computation of GOPS estimations, time series forecasting can be employed for various combinations and permutations of the radio pools. In some implementations, a quantum ML algorithm can be utilized as a service within the RIC to calculate the server resources efficiently.

As shown in process 900, data inputs as shown at 902, including a list of radios to be considered as well as data relating to their radio traffic, UE mobility indices, radio traffic diversity, radio spatial distribution, and/or other properties, can be provided to a first ML model at 904, resulting in a time series prediction of radio traffic, mobility indices, traffic diversity, and/or other properties, e.g., in accordance with various aspects as described above. The output of the first ML model, as shown at 906, can include a list of radios with their respective estimated traffic attributes, as well as the time period for the predicted traffic.

Next, at 908, the BBU server resources needed for the estimated and/or forecasted RU traffic, RU traffic diversity, and/or mobility can be computed by calculating the total GOPS to be provisioned to the radios based on the GBPS.

A condensed list of steps involved in computing the GOPS at 908 is provided below. It is noted that other steps could be used in addition to and/or in place of the listed steps.

1) Characterize radio traffic: Assess traffic characteristics (e.g., data rate, type, mobility, etc.) at the radio level.

2) Determine processing requirements: Analyze baseband processing needs for signal tasks (e.g., modulation, coding, multiple-input multiple-output (MIMO), etc.).

3) Calculate operations per bit: Estimate the number of operations associated with processing one bit based on algorithm complexity.

4) Compute GOPS from GBPS: Multiply the operations per bit by the GBPS to obtain the total operations per second of the BBU.

5) Adjust for hardware efficiency: Consider hardware efficiency, including parallel processing and acceleration techniques.

6) Incorporate overhead: Include additional processing overhead for error correction and encryption.

7) Final calculation: Multiply the adjusted operations per bit by the GBPS to determine the GOPS associated with the BBU.

In an implementation, the outcome of the above steps can include a list of the associated radios along with their calculated amounts of BBU server resources (e.g., cores) needed to support their estimated radio traffic, e.g., as shown at 910.

Next, at 912, graph community pairing and/or other techniques can be used to compute clusters or communities of radio pools with similar needs of BBU server resources. For example, the radios can be classified into distinct bins of low, medium, and/or high usage, or statistical multi-bin groups, using graph community pairing at 912. The attributes used for the graph calculation at 912 can include some or all of the following:

Distance between cells: Accounts for the geographic proximity of radio cells, linking closer cells with stronger connections to reflect spatial traffic patterns.

Traffic burst timing: Evaluates simultaneous traffic bursts in adjacent cells, assigning higher weights for synchronized demand, e.g., to indicate temporal traffic alignment.

UE distribution dispersion: Quantifies the spread of UEs within cells, linking cells with similar dispersion patterns through higher weights to denote UE distribution similarities.

UE mobility patterns: Considers mobility behaviors of UEs, like handovers or stationary use, assigning higher weights to cells with similar mobility trends.

Graph structure: Represents radio cells as nodes, each linked to its CU and DU, facilitating graph community pairing.

In addition, building of the graph community pairing can include steps of some or all of the following:

Graph creation: Constructs a weighted graph with nodes as radio cells (with CU and DU). The edges can reflect spatial and temporal cell correlations.

Edge weight calculation: Calculates edge weights considering cell distance, traffic synchronization, UE distribution, and mobility.

Graph partitioning: Applies community detection (e.g., Louvain Modularity) to segment the graph into communities with similar traffic patterns.

Community analysis: Analyzes each community for service types (URLLC, mMTC, eMBB), traffic trends, and UE mobility.

Periodic adaptation: Continuously updates communities and allocations based on evolving traffic, maintaining network efficiency.

The outcome of the graph community pairing can include a list of radios with their identities in distinct pools or clusters of communities that share common BBU resource needs, e.g., as shown at 914. In an aspect, the operations shown at 904, 908, and 912 can be implemented in a cascade ML pipeline. Based on the list shown at 914, appropriate numbers of servers can be instantiated on the cloud at 916 for the respective pools of radios.

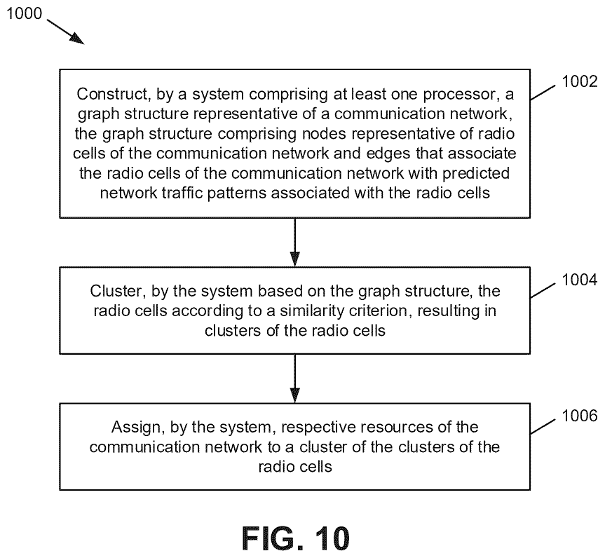

Turning to FIG. 10, a flow diagram of a method 1000 that facilitates graph-based community pairing for radio clustering is illustrated. At 1002, a system comprising at least one processor can construct (e.g., by a network grapher 110) a graph structure (e.g., a graph structure 10) representative of a communication network. The graph structure can include nodes representative of radio cells (e.g., radio cells 20) of the communication network and edges that associate the radio cells of the communication network with predicted network traffic patterns associated with the radio cells.

At 1004, the system can cluster (e.g., by a radio grouper 120) the radio cells based on the graph structure and according to a similarity criterion, resulting in clusters of the radio cells.

At 1006, the system can assign (e.g., by a resource allocator 130) respective resources of the communication network (e.g., servers or portions of servers, such as processors or processor cores) to a cluster of the clusters of the radio cells created at 1004.

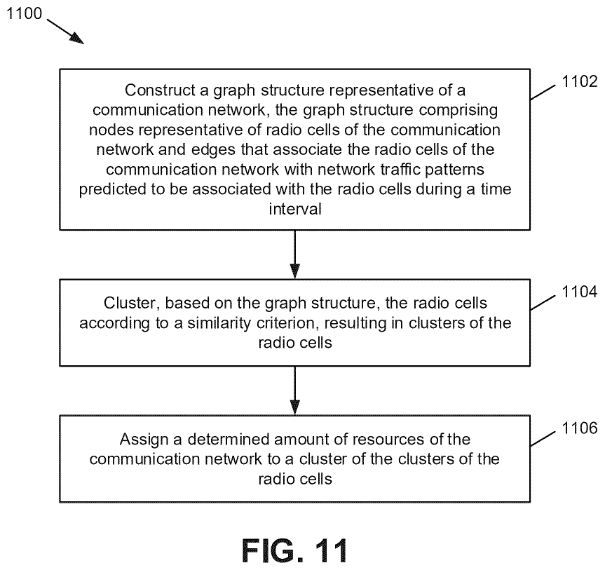

Referring next to FIG. 11, a flow diagram of a method 1100 that can be performed by at least one processor, e.g., based on machine-executable instructions stored on a non-transitory machine-readable medium, is illustrated. An example of a computer architecture, including a processor and non-transitory media, that can be utilized to implement method 1100 is described below with respect to FIG. 12.

Method 1100 can begin at 1102, in which the at least one processor can construct a graph structure representative of a communication network, the graph structure comprising nodes representative of radio cells of the communication network and edges that associate the radio cells of the communication network with network traffic patterns predicted to be associated with the radio cells during a time interval.

At 1104, the at least one processor can cluster, based on the graph structure, the radio cells according to a similarity criterion, resulting in clusters of the radio cells.

At 1106, the at least one processor can assign a determined amount of resources of the communication network to a cluster of the clusters of the radio cells.

FIGS. 10-11 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 12 and the following discussion are intended to provide a brief, general description of a suitable computing environment 1200 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 12, an example general-purpose environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD), a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown).

Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the. NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
generating a graph structure representative of a communication network, the graph structure comprising nodes respectively corresponding to radio cells in the communication network and edges that associate the radio cells with respective predicted patterns in traffic characteristics of the radio cells;
grouping, based on the graph structure, the radio cells of the communication network into clusters of the radio cells according to a similarity criterion; and
assigning respective groups of resources of the communication network to a selected cluster of the clusters of the radio cells.

2. The system of claim 1, wherein the operations further comprise:
applying weights to the edges based on at least one weighting factor selected from a group of weighting factors comprising physical distances between the radio cells respectively corresponding to the nodes, an extent to which traffic bursts processed by the radio cells are synchronized, a dispersion in user equipment distribution associated with the radio cells, and user equipment handover frequencies associated with the radio cells.

3. The system of claim 2, wherein the similarity criterion is based on the weights applied to the edges.

4. The system of claim 1, wherein the operations further comprise:
adjusting the graph structure in response to an identified change in the predicted patterns in the traffic characteristics of the radio cells.

5. The system of claim 1, wherein the grouping of the radio cells comprises partitioning the graph structure into communities of the nodes and selecting, as the clusters of the radio cells, groups of the radio cells corresponding to respective ones of the communities.

6. The system of claim 1, wherein the operations further comprise:
determining service categories associated with network traffic served by respective ones of the clusters of the radio cells, wherein the assigning comprises assigning a group of the respective groups of the resources of the communication network to the selected cluster of the radio cells based on the service categories.

7. The system of claim 6, wherein the service categories are selected from a group of service categories comprising an ultra-reliable low latency communications (URLLC) service category, a massive machine-type communications (mMTC) service category, and an enhanced mobile broadband (eMBB) service category.

8. The system of claim 1, wherein the operations further comprise:
estimating an average data rate processed by the selected cluster of the radio cells over a time interval based on the predicted patterns in the traffic characteristics of the radio cells; and
determining an amount of computing resources associated with processing network traffic at the selected cluster of the radio cells at the average data rate, wherein the assigning comprises assigning the amount of the computing resources to the selected cluster of the radio cells.

9. The system of claim 1, wherein the radio cells comprise respective centralized units and respective distributed units.

10. The system of claim 1, wherein the similarity criterion comprises Jaccard indices of different pairs of the radio cells.

11. A method, comprising:
constructing, by a system comprising at least one processor, a graph structure representative of a communication network, the graph structure comprising nodes representative of radio cells of the communication network and edges that associate the radio cells of the communication network with predicted network traffic patterns associated with the radio cells;
clustering, by the system based on the graph structure, the radio cells according to a similarity criterion, resulting in clusters of the radio cells; and
assigning, by the system, respective resources of the communication network to a cluster of the clusters of the radio cells.

12. The method of claim 11, further comprising:
applying, by the system, weights to the edges based on a weighting factor, wherein the weighting factor is selected from a group of weighting factors comprising physical distances between respective ones of the radio cells represented by the nodes of the graph structure, an extent to which traffic bursts processed by the respective ones of the radio cells are synchronized, a dispersion in user equipment distribution associated with the respective ones of the radio cells, and user equipment handover frequencies associated with the respective ones of the radio cells.

13. The method of claim 12, wherein the similarity criterion is based on the weights applied to the edges.

14. The method of claim 11, wherein the predicted network traffic patterns are first predicted network traffic patterns associated with the radio cells at a first time interval, and wherein the method further comprises:
adjusting, by the system, the graph structure based on second predicted network traffic patterns associated with the radio cells at a second time interval different from the first time interval.

15. The method of claim 11, wherein the clustering comprises:
partitioning the graph structure into communities of the nodes; and
selecting, as the clusters of the radio cells, groups of the radio cells corresponding to respective ones of the communities.

16. A non-transitory machine-readable medium comprising computer executable instructions that, when executed by at least one processor, facilitate performance of operations, the operations comprising:
constructing a graph structure representative of a communication network, the graph structure comprising nodes representative of radio cells of the communication network and edges that associate the radio cells of the communication network with network traffic patterns predicted to be associated with the radio cells during a time interval;
clustering, based on the graph structure, the radio cells according to a similarity criterion, resulting in clusters of the radio cells; and
assigning a determined amount of resources of the communication network to a cluster of the clusters of the radio cells.

17. The non-transitory machine-readable medium of claim 16, wherein the operations further comprise:
applying weights to the edges based on a weighting factor selected from a group of weighting factors comprising physical distances between respective ones of the radio cells represented by the nodes of the graph structure, an extent to which traffic bursts processed by the respective ones of the radio cells are synchronized, a dispersion in user equipment distribution associated with the respective ones of the radio cells, and user equipment handover frequencies associated with the respective ones of the radio cells.

18. The non-transitory machine-readable medium of claim 17, wherein the similarity criterion is based on the weights applied to the edges.

19. The non-transitory machine-readable medium of claim 16, wherein the network traffic patterns are first network traffic patterns, wherein the time interval is a first time interval, and wherein the operations further comprise:
adjusting the graph structure based on second network traffic patterns predicted to be associated with the radio cells during a second time interval.

20. The non-transitory machine-readable medium of claim 16, wherein the clustering comprises:
partitioning the graph structure into communities of the nodes; and
selecting, as the clusters of the radio cells, groups of the radio cells corresponding to respective ones of the communities.
